(19) United States
(12) Patent Application Publication
(10) Pub. No.: US 2001/0006707 A1
(43) Pub. Date: Jul. 5, 2001

(54) Method and apparatus for thermal barrier coating and removal

(76) Inventors: Gilbert Farmer, Cincinnati, OH (US); Jeffrey A. Fehrenbach, Cincinnati, OH (US); William L. Imhoff, Hamilton, OH (US); Timothy M. Martinkovic, Hamilton, OH (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/736,893

(22) Filed: Dec. 14, 2000

Related U.S. Application Data
(63) Continuation-in-part of application No. 09/448,595, filed on Nov. 24, 1999.

(51) Int. Cl. B05D 1/36; B05D 1/08; B05D 3/10; B08B 3/02

(52) U.S. Cl. 427/446; 134/167 R; 134/172; 427/405; 427/349

(57) ABSTRACT

A method of applying thermal barrier coating systems to a metal piece having a cooling hole extending along a central axis through the piece from a first surface of the piece to a second surface opposite the first surface. The method includes spraying a bond coat and a thermal barrier coating on the first surface at an angle and to a thickness to prevent the bond coat and thermal barrier coating from entirely filling the hole. The method also includes spraying a high pressure fluid jet from an elongate nozzle assembly having an orifice configured to direct the jet laterally away from the nozzle assembly toward the hole and in a direction generally parallel to the central axis of the hole.

### CROSS-REFERENCE TO RELATED APPLICATION

This is a continuation-in-part of U.S. patent application Ser. No. 09/448,595 filed Nov. 24, 1999, which is hereby incorporated by reference.

### BACKGROUND OF THE INVENTION

The present invention relates generally to a method and apparatus for applying and removing thermal barrier coatings from a metal piece, and more particularly to a method and apparatus for applying and removing coatings from a piece having cooling holes.

Various methods are used to protect metal pieces exposed to high temperature environments. For instance, cooling air is sometimes blown over the piece. In some applications such as aircraft engine combustion chamber liners, cooling holes are formed in the liner for directing film cooling air through the liner and over surfaces of the liner exposed to high temperatures. The film cooling air cools the liner and forms a fluid barrier between the liner and hot gases which flow through the engine. The film of cooling air prevents the gases from directly contacting the liner. In addition, thermal barrier coatings are applied to surfaces of metal pieces exposed to high temperature environments to reduce the amount of heat which is transferred to the metal substrate. However, if the thermal barrier coatings are damaged (e.g., by field exposure or handling damage) the protection offered by the coatings may be compromised.

Although damaged thermal barrier coating can be repaired by conventional methods of stripping the damaged coating and applying a new coating to the piece, cooling holes must be masked before applying the new coating or drilled (e.g., by laser drilling) after applying the new coating to ensure the holes are not blocked by the coating. These masking or drilling operations increase the cost of repairing damaged thermal barrier coatings.

### SUMMARY OF THE INVENTION

Briefly, the present invention includes a method of applying thermal barrier coating systems to a metal piece having a cooling hole extending along a central axis through the piece from a first surface of the piece to a second surface of the piece opposite the first surface. The method comprises the step of spraying a bond coat on the first surface of the piece at an angle with respect to the central axis of the hole and to a thickness selected in combination with the angle at which the bond coat is sprayed to prevent the bond coat from entirely filling the hole. A thermal barrier coating is sprayed on the bond coat at an angle with respect to the central axis of the hole and to a thickness selected in combination with the angle at which the thermal barrier coating is sprayed to prevent the thermal barrier coating from entirely filling the hole. Further the method includes the step of spraying a high pressure fluid jet from an elongate nozzle assembly having an orifice configured to direct the jet laterally away from the nozzle assembly toward the hole and in a direction generally parallel to the central axis of the hole.

Briefly, apparatus of this invention includes a nozzle assembly for spraying a high pressure fluid jet through a cooling hole in a metal piece having a predetermined diameter to remove a bond coat and a thermal barrier coating from the hole. The nozzle assembly comprises a body having an interior passage extending through the body for transporting pressurized fluid from a fluid source to an orifice having a diameter less than the predetermined diameter of the cooling hole.

In another aspect of the invention, the nozzle assembly comprises an elongate body having an interior passage extending along a central axis through the body for transporting pressurized fluid from a fluid source to a distal end of the body. The body also includes an orifice positioned at the distal end of the body and being configured to direct fluid laterally away from the central axis of the interior passage of the body toward the cooling hole.

Other features of the present invention will be in part apparent and in part pointed out hereinafter.

### BRIEF DESCRIPTION OF THE DRAWINGS

FIG. 1 is an elevation of a thermal barrier coating spray apparatus used in the method of the present invention;

FIG. 2 is an elevation of a water jet apparatus used in the method of the present invention;

FIG. 3 is a cross section of a piece having a bond coat applied by the thermal barrier coating spray apparatus;

FIG. 4 is a cross section of the piece after the bond coat is removed from a cooling hole by the water jet apparatus;

FIG. 5 is a cross section of the piece having a thermal barrier coating applied by the thermal barrier coating spray apparatus;

FIG. 6 is a cross section of a coated piece after the thermal barrier coating is removed from the cooling hole by the water jet apparatus;

FIG. 7 is a cross section of a piece showing coating being removed from a cooling hole by a water jet apparatus having an angled nozzle;

FIG. 8 is a perspective of the angled nozzle;

FIG. 9 is a fragmentary side elevation of the angled nozzle; and

FIG. 10 is a cross section of a tip of the angled nozzle.

Corresponding reference characters indicate corresponding parts throughout the several views of the drawings.

### DETAILED DESCRIPTION OF THE PREFERRED EMBODIMENT

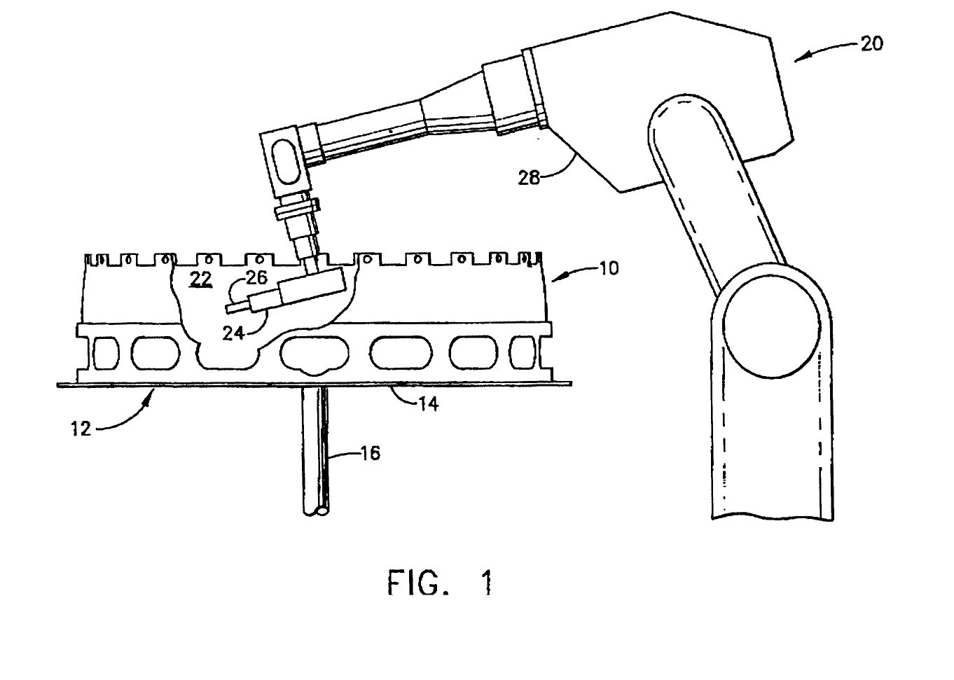

Referring now to the drawings and in particular to FIG. 1, a metal piece such as an outer combustion chamber liner of an aircraft engine is designated in its entirety by the reference number 10. The metal piece 10 may be a new piece which has never had a thermal barrier coating system or it may be a repaired piece from which damaged thermal barrier coating has been removed by conventional mechanical and/or chemical stripping processes. The metal piece 10 is received by a conventional turntable, generally designated by 12, having a support 14 sized and shaped for receiving the piece and a central vertical shaft 16 for rotating the support. A conventional thermal barrier coating spray apparatus, generally designated by 20, is provided adjacent the turntable 12 for applying a thermal barrier system (i.e., bond coats and thermal barrier coatings) to a first surface 22 of the metal piece 10. The apparatus 20 includes a spray head 24 having a nozzle 26 through which the thermal barrier system is sprayed and a robotic arm 28 for manipulating the head into position relative to the metal piece 10. Although other apparatus may be used without departing from the scope of the present invention, the thermal barrier coating spray apparatus 20 of the preferred embodiment is an ATCS plasma system with an 8-axis computer numerically controlled Fanuc robot system available from Sulzer Metco of Westbury, N.Y.

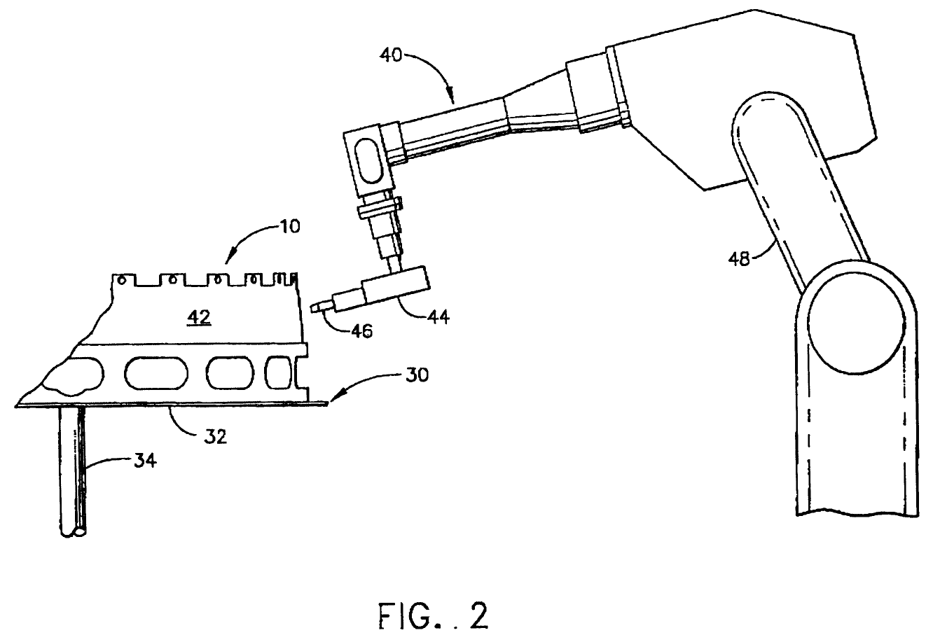

FIG. 2 illustrates the metal piece 10 received by another conventional turntable, generally designated by 30, comprising a support 32 and a central vertical shaft 34 for rotating the support. A conventional water jet apparatus, generally designated by 40, adjacent the turntable 30 sprays water toward the metal piece 10 onto a second surface 42 of the piece opposite the first surface 22 (FIG. 1). The water jet apparatus 40 includes a spray head 44 having a nozzle 46 for spraying a high pressure jet of fluid such as water toward the piece and a robotic arm 46 for manipulating the head into position relative to the metal piece 10. Although other apparatus may be used without departing from the scope of the present invention, the water jet apparatus 40 of the preferred embodiment is a Model No. 1015 5-axis computer numerically controlled water jet system available from Progressive Technologies of Grand Rapids, Mich. As the previously described thermal barrier coating spray apparatus and water jet apparatus are conventional and well understood by those skilled in the art, they will not be described in further detail.

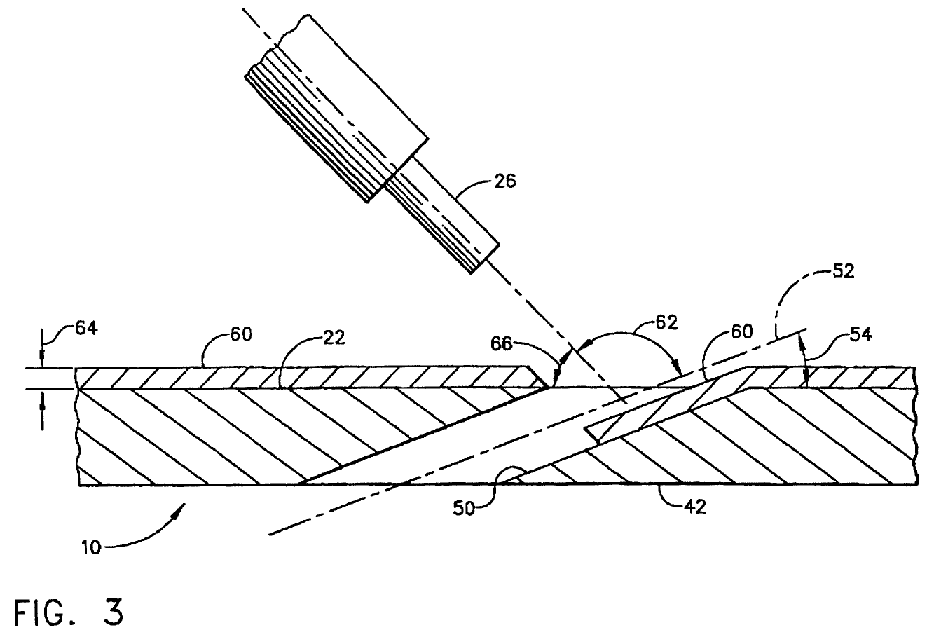

As illustrated in FIG. 3, the metal piece 10 has a series of cooling holes (only one of which is shown) defined by tubular surfaces 50 aligned in a row extending tangentially around the piece. Each cooling hole 50 extends along a central axis 52 through the piece from the first surface 22 of the piece to the second surface 42 of the piece opposite the first surface. The central axis 52 of the hole is oriented at an angle 54 (e.g., twenty degrees) with respect to the first surface 22 of the piece 10. The size and orientation of the hole are not critical to the present invention.

As further illustrated in FIG. 3, the thermal barrier coating spray apparatus 20 is operable to spray a bond coat 60 such as NiCrAlY on the first surface 22 of the piece 10 at a spray angle 62 measured with respect to the central axis 52 of the hole and to a thickness 64 selected in combination with the angle 62 to prevent the bond coat from entirely filling the hole. Although the spray angle 62 may vary without departing from the scope of the present invention, the angle 62 is preferably greater than ninety degrees (i.e., obtuse) to minimize the amount of bond coat sprayed on the surface 50 defining the hole opposite the spray nozzle 26. Further, the bond coat 60 is preferably sprayed on the first surface 22 at an angle of incidence 66 measured with respect to the first surface of at least about 45 degrees. Angles of incidence 66 less than about 45 degrees tend to cause the coat 60 to have unmelted areas, voids and lower tensile strength.

As previously mentioned, the spray angle 62 and the thickness 64 are selected in combination to prevent the bond coat from entirely filling the hole. For example, for a piece 10 having nominal 0.020 to 0.030 inch diameter holes extending at an angle 54 of approximately twenty degrees, the bond coat 60 may be sprayed on the first surface 22 at an angle of incidence 66 of about 45 degrees and an angle 62 with respect to the central axis 52 of the hole of about 135 degrees. Further, the bond coat 60 is sprayed to a thickness 64 of between about 0.004 inches and about 0.010 inches, and more preferably to a thickness of between about 0.004 inches and about 0.006 inches. As will be appreciated by those skilled in the art, the angles and thickness may be varied without departing from the scope of the present invention. However, it is desirable that the angle 62 measured with respect to the central axis 52 and the thickness 66 be selected so that the bond coat does not entirely fill the hole. The unfilled portion of the hole provides a pilot hole so that the water jet apparatus can remove the bond coat 60 from the hole as will be explained below.

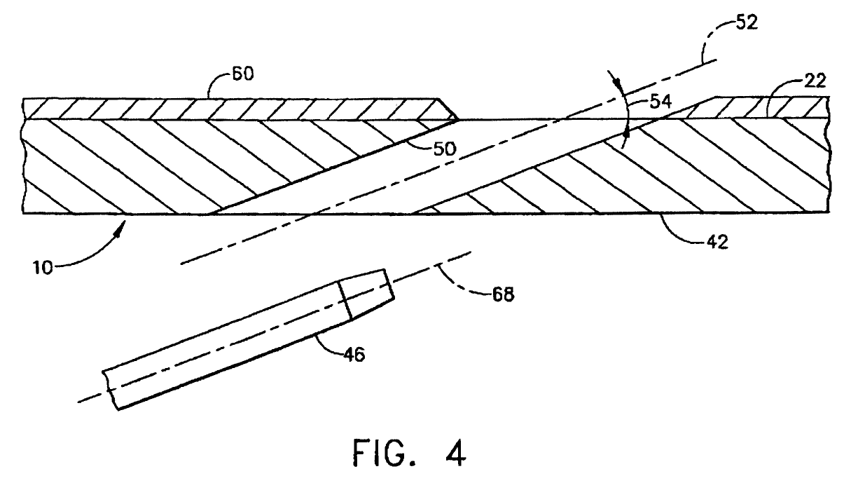

After the bond coat 60 is applied, the piece 10 is placed on the turntable support 30 adjacent the water jet apparatus 40. As shown in FIG. 4, the water jet apparatus 40 sprays a high pressure water jet toward the hole from a nozzle 46 facing the second surface 42 of the piece 10 and in a direction 68 generally parallel to the central axis 52 of the hole. The water jet is substantially free of solid particulate so the jet removes only the bond coat 60 from the hole 52 without removing metal from the piece 10. As previously mentioned, a pilot hole is needed to permit the water jet to remove the bond coat 60 from the hole. This is because the water jet abrades the bond coat 60 rather than pushing it from the hole. If the pilot hole is not present, the abrasion capability of the water jet is reduced. Although the water jet may be sprayed at other pressures without departing from the scope of the present invention, the water jet apparatus of the preferred embodiment produces a water jet having a pressure of between about 5000 pounds per square inch and about 50,000 pounds per square inch. Preferably, the water jet is sprayed from the nozzle 46 at a pressure of about 45,000 pounds per square inch.

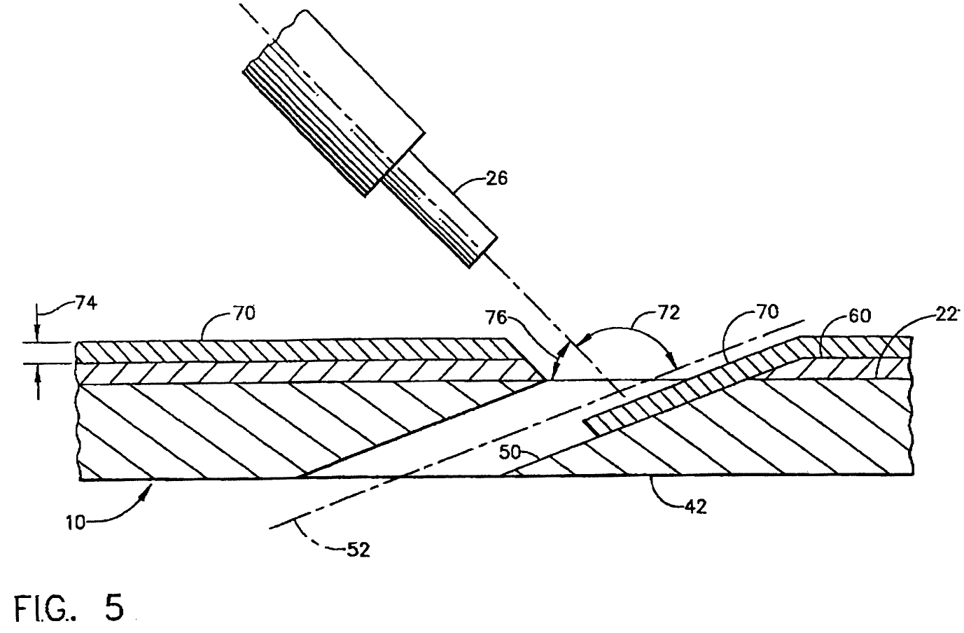

After the bond coat 60 is removed from the hole, the piece 10 is returned to the first turntable 12. As illustrated in FIG. 5, the thermal barrier coating spray apparatus 20 sprays a thermal barrier coating 70 such as yttria stabilized zirconia on the bond coat 60 at a spray angle 72 measured with respect to the central axis 52 of the hole and to a thickness 74 selected in combination with the angle at which the thermal barrier coating is sprayed to prevent the thermal barrier coating from entirely filling the hole. Further, the thermal barrier coating 70 is preferably sprayed on the bond coat 60 at an angle of incidence 76 with respect to the bond coat surface of at least about 45 degrees. Angles of incidence 76 less than about 45 degrees tend to cause the coating 70 to have unmelted areas, voids and lower tensile strength.

As with the bond coat parameters, the spray angle 72 and the thickness 74 are selected in combination to prevent the thermal barrier coating from entirely filling the hole. For example, for the previously described piece 10 having nominal 0.020 to 0.030 inch diameter holes extending through the piece at an angle 54 of approximately twenty degrees, the thermal barrier coating 70 may be sprayed on the bond coat 60 at an angle of incidence 76 of about 45 degrees and a spray angle 72 of about 135 degrees. Further, the coating 70 is sprayed in at least one coat having a thickness 74 of between about 0.003 inches and about 0.015 inches. Preferably, the coating 70 is sprayed in a coat having a thickness 74 of about 0.010 inches. As will be appreciated by those skilled in the art, the angles and thickness may be varied without departing from the scope of the present invention. However, it is desirable that the spray angle 72 and the thickness 74 be selected so that the coating 70 does not entirely fill the hole. As with the bond coat, leaving a pilot hole in the thermal barrier coating enables the water jet to remove the coating 70 from the hole.

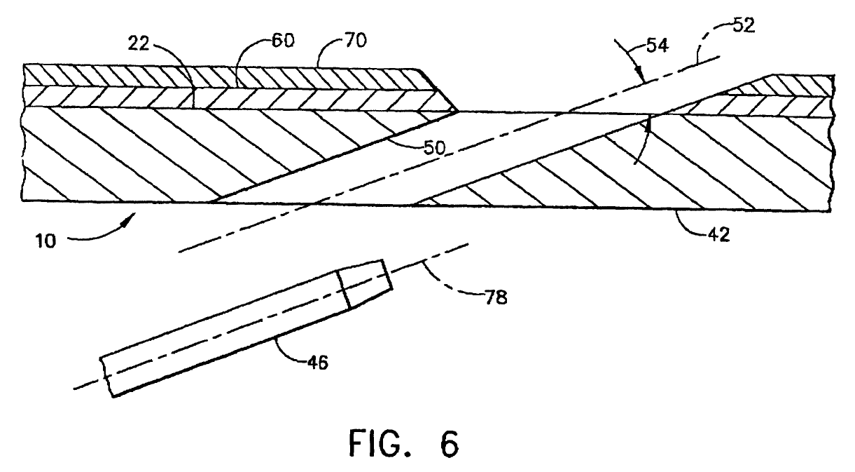

After the thermal barrier coating 70 is applied, the piece 10 is placed on the turntable support 30 adjacent the water jet apparatus 40 (FIG. 6). The water jet apparatus 40 sprays a high pressure water jet toward the hole from the nozzle 46 facing the second surface 42 of the piece 10 and in a direction 78 generally parallel to the central axis 52 of the hole to remove thermal barrier coating from the hole. Because the water jet is substantially free of solid particulate, the jet only removes the thermal barrier coating 70 from the hole without removing metal from the piece 10. Although the water jet pressure may vary without departing from the scope of the present invention, in the preferred embodiment the water jet pressure used during this spraying step is identical to the pressure used during the prior spraying step.

After the thermal barrier coating 70 is removed from the hole, additional layers of thermal barrier coating (not shown) may be applied to the piece 10 to build the total coating thickness. Preferably, the coating 70 is removed from the hole after applying each layer. As will be appreciated by those skilled in the art, the step of spraying the piece with the water jet after the bond coat 60 is applied and before the thermal barrier coating 70 is applied may be omitted if the combined thickness of the layers is thin enough that they do not entirely fill the hole thereby allowing the layers to be removed together.

Because the water jet does not damage the base metal of the piece 10, its flow need not be interrupted as the jet travels from hole to hole. Further, where the piece 10 has a series of holes, either the piece or the water jet nozzle 46 (or both) may be moved with respect to the other to sequentially align the water jet with each of the holes in the series. For example, where the piece 10 is circular and the series of holes is oriented in a row extending circumferentially around the piece, the piece may be rotated to move the piece with respect to the nozzle 46 and to align the nozzle with each hole of the series. A motor (not shown) connected to the shaft 34 may be used to continuously rotate the turntable 30 and piece 10. Although the piece 10 and the nozzle 46 may be moved at other rates without departing from the scope of the present invention, in the preferred embodiment they are moved at a relative speed of between about twenty inches per minute and about 480 inches per minute. In a particularly preferred embodiment, the piece 10 is moved relative to the nozzle 46 at a rate of about twenty inches per minute. Although the turntable 30 of the preferred embodiment rotates continuously, it is envisioned that the turntable may be rotated intermittently so the water jet dwells when aligned with each hole.

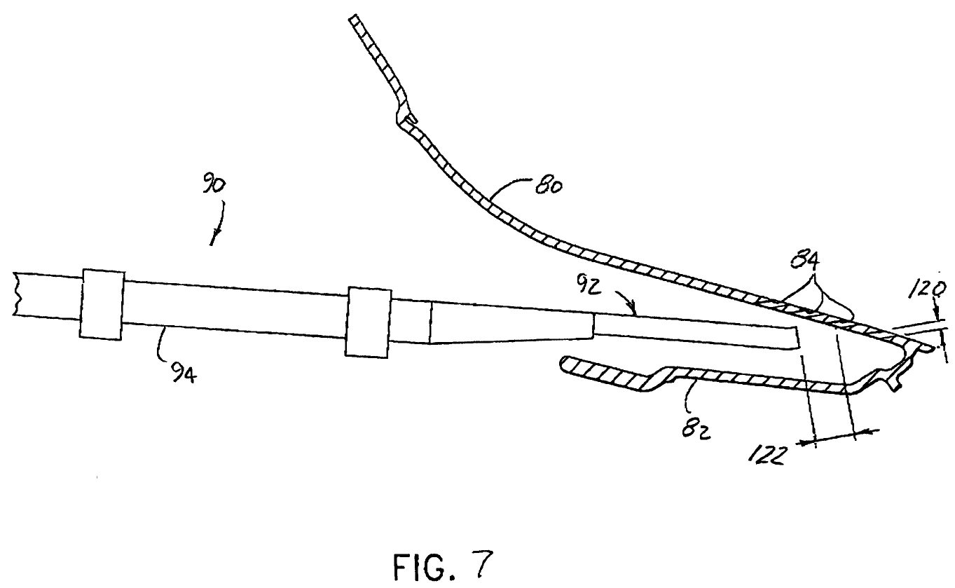

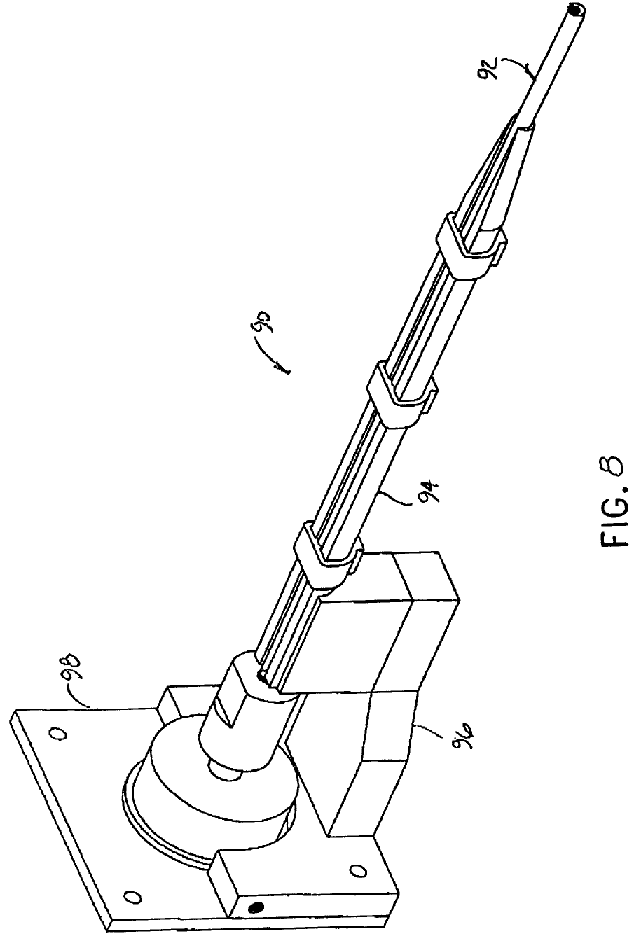

Although the previously described method and water jet apparatus 40 work well for many applications, in some applications such as where a work piece 80 has a portion 82 which prevents direct line-of-sight access to some cooling holes 84 as shown in FIG. 7, a water jet apparatus of a second embodiment, generally designated by 90, is preferably used. As illustrated in FIG. 8, the water jet apparatus 90 includes a nozzle assembly, generally designated by 92, for spraying a high pressure fluid jet, a support 94 for supporting the nozzle assembly, a brace 96 for further supporting the nozzle assembly, and a mount 98 for mounting the nozzle assembly to the water jet apparatus. As will be appreciated by those skilled in the art, the sizes and shapes of the supports 94 and braces 96 are selected to reduce vibrations of the nozzle assembly 92 caused by the fluid jet. The nozzle assembly 92 sprays a high pressure fluid jet through the cooling holes 84 in the metal piece 80 to remove the bond coat and the thermal barrier coating from the hole as previously described.

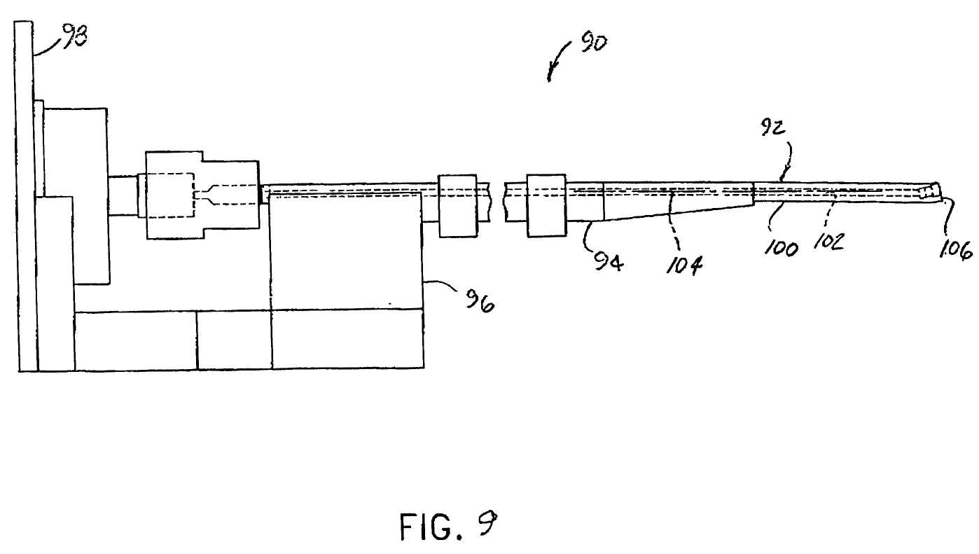

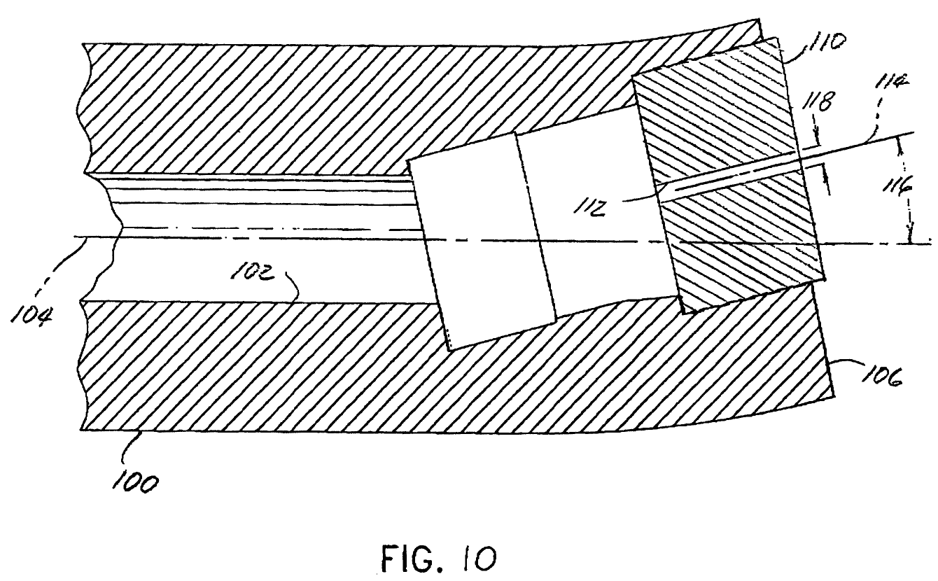

As illustrated in FIG. 9, the nozzle assembly 92 includes an elongate body 100 having an interior passage 102 extending along a central axis 104 through the body for transporting pressurized fluid from a fluid source (not shown) to a distal end 106 of the body. As shown in FIG. 10, a nozzle 110 having an exit port or orifice 112 is positioned at the distal end 106 of the body 100. The orifice 112 is configured to direct fluid laterally in a direction diverging away from the central axis 104 of the interior passage 102 of the body 100 toward the cooling hole 84. Although the orifice 112 may be configured to direct fluid in other directions without departing from the scope of the present invention, in one embodiment the orifice is directed generally along a line 114 diverging at an angle 116 of about twenty degrees with respect to the central axis 104 of the interior passage 102 of the body 100.

Although the orifice 112 may have other diameters without departing from the scope of the present invention, in one embodiment the orifice has a diameter 118 less than a predetermined diameter 120 (FIG. 7) of the cooling hole 84. It is envisioned that the diameter 118 of the orifice 112 may be about eighty percent of the predetermined diameter 120 of the cooling hole 84. Thus, for cooling holes 84 having a predetermined diameter 120 of about 0.020 inches, it is envisioned that the diameter 118 of the orifice 112 might be about 0.016 inches. However, it is also envisioned that larger orifice diameters 118 (e.g., between about 0.016 inches and about 0.020 inches) may be used without departing from the scope of the present invention. Orifice diameters 118 greater than the cooling hole diameter 120 are not preferred because these larger diameters permit portions of the fluid jet to impinge on the metal surrounding the cooling hole 84 rather than directing the entire jet through the cooling hole where it has the potential of removing coatings.

The method of using the water jet apparatus of the second embodiment 90 is similar to that described above with respect to the water jet apparatus of the first embodiment 40. As illustrated in FIG. 3, a bond coat 60 is sprayed on the metal work piece 10 at an angle 66 and to a thickness 64 selected to prevent the bond coat from entirely filling the hole 84. The water jet apparatus 90 is used to spray a high pressure fluid jet in a direction generally parallel to the central axis 52 of the cooling holes 84 to remove bond coat 60 from them. After the bond boat 60 is removed from the holes 84, a thermal barrier coating 70 is sprayed on the bond coat 60 as shown in FIG. 5 at an angle 76 and to a thickness 74 selected to prevent the thermal barrier coating from entirely filling the hole 84. The step of spraying the high pressure fluid jet is repeated to remove thermal barrier coating 70 from the cooling holes 84.

Although the fluid jet may be sprayed at other pressures without departing from the scope of the present invention, in one embodiment the fluid jet is sprayed from the nozzle orifice 112 at a pressure of between about 5000 pounds per square inch and about 50,000 pounds per square inch, and more particularly, at a pressure of about 45,000 pounds per square inch. Although the orifice 112 of the nozzle assembly 90 may be spaced from the metal piece 10 by other distances without departing from the scope of the present invention, in one embodiment the orifice of the nozzle assembly is spaced from the metal piece by a distance 122 of between about 0.1 inches and about 3 inches as shown in FIG. 7 while the fluid jet is sprayed from the nozzle assembly. Further, it is envisioned that it may be beneficial that the orifice 112 of the nozzle assembly 90 be spaced from the metal piece 10 by a distance 122 of between about 0.8 inches and about 1.6 inches while the jet is sprayed from the assembly.

In addition, although the orifice 112 may be moved relative to the metal piece at other speeds without departing from the scope of the present invention, in one embodiment the orifice of the nozzle assembly 90 is moved relative to the metal piece 10 at a speed of between about 20 inches per minute and about 480 inches per minute as the fluid jet is sprayed from the nozzle assembly. It is further envisioned that it may be beneficial to move the orifice 112 relative to the metal piece 10 at a speed of about 240 inches per minute as the fluid jet is sprayed from the nozzle assembly 90. Although the nozzle assembly 90 may be aligned in other orientations without departing from the scope of the present invention, in one embodiment the nozzle assembly is aligned generally parallel to the second surface 22 of the metal piece 10 while the jet is sprayed from the assembly 90.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions and methods without departing from the scope of the invention, it is intended that all matter contained in the above description or shown in the accompanying drawings shall be interpreted as illustrative and not in a limiting sense.

What is claimed is:

1. A method of applying thermal barrier coating systems to a metal piece having a cooling hole extending along a central axis through the piece from a first surface of the piece to a second surface of the piece opposite the first surface, said method comprising the steps of:
spraying a bond coat on said first surface of the piece at an angle with respect to the central axis of the hole and to a thickness selected in combination with the angle at which the bond coat is sprayed to prevent the bond coat from entirely filling the hole;
spraying a thermal barrier coating on the bond coat at an angle with respect to the central axis of the hole and to a thickness selected in combination with the angle at which the thermal barrier coating is sprayed to prevent the thermal barrier coating from entirely filling the hole; and
spraying a high pressure fluid jet from a nozzle assembly having an orifice configured to direct the jet in a direction diverging away from a central longitudinal axis of the nozzle assembly and generally parallel to the central axis of the hole.

2. A method as set forth in claim 1 wherein the step of spraying the high pressure fluid jet from the nozzle is performed at least twice, once after the step of spraying the bond coat but before the step of spraying the thermal barrier coating to remove the bond coat from the hole, and again after the step of spraying the thermal barrier coating to remove the thermal barrier coating from the hole.

3. A method as set forth in claim 1 wherein the thermal barrier coating is sprayed on said first surface in at least two coats and the step of spraying the fluid from the nozzle is performed at least twice, once after spraying a first coat of said coats of thermal barrier coating and again after spraying a second coat of said coats of thermal barrier coating.

4. A method as set forth in claim 1 wherein the fluid jet is sprayed from the nozzle toward the second surface of the metal piece.

5. A method as set forth in claim 1 wherein the fluid jet is sprayed from the nozzle at a pressure of between about 5000 pounds per square inch and about 50,000 pounds per square inch.

6. A method as set forth in claim 6 wherein the fluid jet is sprayed from the nozzle at a pressure of about 45,000 pounds per square inch.

7. A method as set forth in claim 1 wherein the orifice of the nozzle assembly is spaced from the metal piece by a distance of between about 0.1 inches and about 3 inches while spraying the fluid jet from the nozzle assembly.

8. A method as set forth in claim 7 wherein the orifice of the nozzle assembly is spaced from the metal piece by a distance of between about 0.8 inches and about 1.6 inches while the jet is sprayed from the assembly.

9. A method as set forth in claim 1 further comprising the step of moving the orifice of the nozzle assembly relative to the metal piece at a speed of between about 20 inches per minute and about 480 inches per minute as the fluid jet is sprayed from the nozzle assembly.

10. A method as set forth in claim 9 wherein the orifice is moved relative to the metal piece at a speed of about 240 inches per minute as the fluid jet is sprayed from the nozzle assembly.

11. A method as set forth in claim 1 wherein the nozzle assembly is aligned generally parallel to the second surface of the metal piece while the jet is sprayed from the assembly.

12. A nozzle assembly for spraying a high pressure fluid jet through a cooling hole in a metal piece having a predetermined diameter to remove a bond coat and a thermal barrier coating from the hole, the nozzle assembly comprising a body having an interior passage extending through the body for transporting pressurized fluid from a fluid source to an orifice having a diameter less than the predetermined diameter of the cooling hole.

13. A nozzle assembly as set forth in claim 12 wherein the diameter of the orifice is about eighty percent of the predetermined diameter of the cooling hole.

14. A nozzle assembly as set forth in claim 12 wherein the diameter of the orifice is between about 0.016 inches and about 0.020 inches.

15. A nozzle assembly as set forth in claim 14 wherein the diameter of the orifice is about 0.016 inches.

16. A nozzle assembly as set forth in claim 12 wherein the interior passage extends along a central axis to a distal end of the body, and the orifice is positioned at the distal end of the body and is configured to direct fluid in a direction diverging away from the central axis of the interior passage of the body toward the cooling hole.

17. A nozzle assembly as set forth in claim 16 wherein the orifice is configured to direct fluid generally along a line diverging at an angle of about twenty degrees with respect to the central axis of the interior passage of the body.

18. A nozzle assembly for spraying a high pressure fluid jet through a cooling hole in a metal piece to remove a bond coat and a thermal barrier coating from the hole, the nozzle assembly comprising an elongate body having an interior passage extending along a central axis through the body for transporting pressurized fluid from a fluid source to a distal end of the body, and an orifice positioned at the distal end of the body and being configured to direct fluid in a direction diverging away from the central axis of the interior passage of the body toward the cooling hole.

19. A nozzle assembly as set forth in claim 18 wherein the orifice is configured to direct fluid generally along a line diverging at an angle of about twenty degrees with respect to the central axis of the interior passage of the body.
